(19) United States
(12) Patent Application Publication
(10) Pub. No.: US 2022/0010962 A1
(43) Pub. Date: Jan. 13, 2022

(54) ELECTRIC KAMADO GRILL

(71) Applicant: EMPIRE COMFORT SYSTEMS, INC., Belleville, IL (US)

(72) Inventors: Nick Bauer, Belleville, IL (US); George Samaras, Doraville, GA (US)

(21) Appl. No.: 17/369,089

(22) Filed: Jul. 7, 2021

Related U.S. Application Data
(60) Provisional application No. 63/048,949, filed on Jul. 7, 2020.

(51) Int. Cl. F24C 1/06; F24C 7/08; A47J 37/07; A47J 36/32; A47J 36/06

(52) U.S. Cl. CPC F24C 1/06; F24C 7/087; A47J 37/0709; A47J 2202/00; A47J 37/0786; A47J 36/06; A47J 36/32

(57) ABSTRACT

A kamado-style grill fitted with an electric heat source for generating heat internal to the grill. A control panel is positioned external to the grill for allowing a user to activate and adjust the temperature internal to the grill by adjusting the output of the electric heat source. Optionally, the kamado-style grill is designed as a dual use cooking device. The electric heat source may thus be removed from the interior of the grill and replaced by a panel for protecting the control panel, allowing the grill to be reconfigured as a wood or charcoal grill.

### CROSS-REFERENCE TO RELATED APPLICATIONS

This application claims priority to U.S. Application 63/048,949 filed Jul. 7, 2020, entitled “ELECTRIC KAMADO GRILL” which is incorporated herein by reference.

### STATEMENT REGARDING FEDERALLY SPONSORED RESEARCH OR DEVELOPMENT

Not Applicable.

### BACKGROUND

The present disclosure relates to ceramic grills, and more particularly, to a kamodo-style grill fitted with an electric heating element.

Kamado Grills have been in use for thousands of years. These grills are typically egg-like in shape and are made of a ceramic or stone like material. They are known for their ability to sustain temperatures and to provide a convective cooking environment, resulting in high-quality cooked food.

The egg-like design of the Kamado grill provides several advantages that lend to high quality cooked food. First, the general shape provides for continuous convection. As the air towards the bottom is heated it rises displacing the slightly cooler air towards the top. The cooler air will circulate towards the outer diameter of the grill and fall towards the heating elements, conventionally, charcoal or wood. As the cooler air contacts the heating elements, it rises again, displacing the cooler air at the top. This cycle continues while a heat source is present.

Second, ceramic or stone like materials are known for their ability to maintain a temperature with very little fluctuation, even at temperatures in excess of 1000° F. This stability in temperature is especially optimal for grilling or smoking, as these styles of cooking require very stable temperatures for perfecting the cooked product.

Using charcoal or wood as the heating source is very common in Kamado-style grills. One major drawback is that these fuel sources can have an excess of ash or small chunks that will build up in the base of the grill. While there may be a grate, or holes that allow for the remnants to fall into a chamber positioned below the grill, the buildup of some small chunks is inevitable and will eventually clog up the holes near the bottom of the base intended to allow ash to be removed. After many uses, cleaning will be required. Larger Kamado-style grills can be very heavy, in excess of 300 lbs and may break very easily if dropped. Therefore, the process of cleaning the buildup of ash and small chunks of burnt wood or charcoal can be a very lengthy and tedious process.

There are benefits in using Kamado-style grills to cook food. Many advocates believe the food just tastes better. Therefore, using kamado-style and ceramic grills is highly desired, but without the buildup of ash and remnant pieces of wood or charcoal, or without the required cleanup.

Electric grills have been in use for decades. They provide many distinct advantages lending to a convenient, clean, simple cooking experience. They use an electric coil as the heat source that produces very little byproducts making them ideal for spaces where cleanup is not easily accessible, or where space is an issue. They do not generate excessive smoke or fumes, which may be present with traditional wood or charcoal grills. They do not have many moving or mechanical parts, which may be the case with gas grills, making them very reliable and dependable. For these reasons, they are ideal for apartment balconies, travel, camping, and under many other circumstances where simplicity and ease of use is required. Furthermore, they provide for easy temperature control, often only requiring the user to adjust a dial. This makes them the optimal choice when convenience is required.

Traditionally, kamado-style grills have been used for cooking over open natural heat only. The effort required to install an electric control panel, an electric heat source and other aspects of an electric Kamado-style grill undoubtedly discouraged any such efforts prior to the instant disclosure.

### BRIEF SUMMARY

The present application combines the quality of kamado-style grilling with the convenience of an electric grill. Disclosed herein is a kamado-style grill with an electric heating element and configured to maximize the benefits of both classic cooking techniques.

The present application discloses a cooking device that generally is formed like a ceramic kamado-style grill. It includes an outer shell with a base and a top cover. The base has supports for standing the grill upright, preferably, handles for a user to move the grill, a control panel for a user to access, heat and control the grill, and a position, such as a rim or lip, for supporting the grate or other cooking surface on the interior. The top cover has a handle for opening the grill, preferably a thermometer for providing temperature readout to the user, and a vent for controlling the level of smoke or heat. The top cover is rotatably attached to the base, e.g., by a pair of hinges positioned towards the sides of the base. The top cover can be rotated upward and rearwards to open the grill. In the closed position, the top cover and the base close to create an inner cavity where the cooking (or smoking) food is placed. The control panel is positioned on the base and preferably faces externally so that the user can interact with the grill. The grill uses an electric heating element that may be controlled by the user through the control panel, and it preferably further includes a temperature sensor for allowing the user to set an automatic temperature adjustment setting.

A method of cooking using the electric kamado-style grill as disclosed herein is also disclosed.

These features, and other features of the present disclosure are presented herein with reference to the drawings and in the following detailed description.

### BRIEF DESCRIPTION OF THE DRAWINGS

FIG. 1a is a top plan view of a prior art kamado grill.

FIG. 1b is a perspective view of a prior art kamado grill.

FIG. 1c is a front elevational view of a prior art kamado grill.

FIG. 2 is a front elevational view of an embodiment of a kamado grill.

FIG. 3a is a perspective view of an embodiment of a kamado grill.

FIG. 3b is a front elevational view an embodiment of a kamado grill.

FIG. 4 is a perspective view of a kamado grill with a front panel.

FIG. 5 is a perspective view of a kamado grill with an electric coil heat source.

FIG. 6 is a perspective view of a kamado grill with an electric coil heat source.

FIG. 7 is a perspective view of a control panel of a kamado grill.

FIG. 8 is an exploded view of the control panel of a kamado grill.

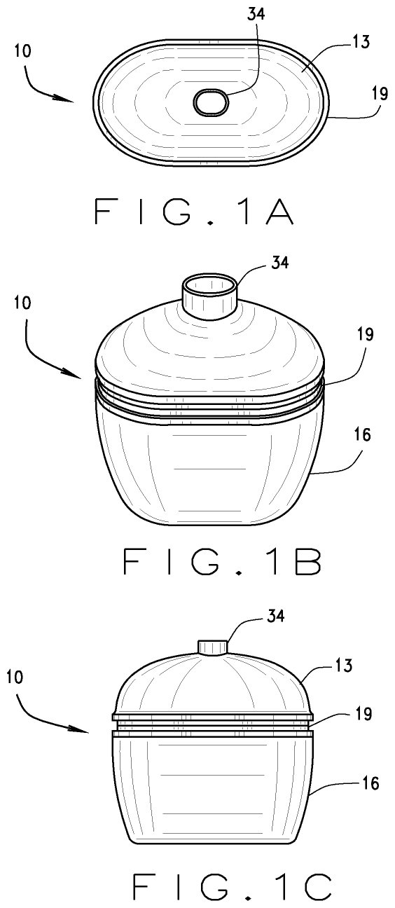

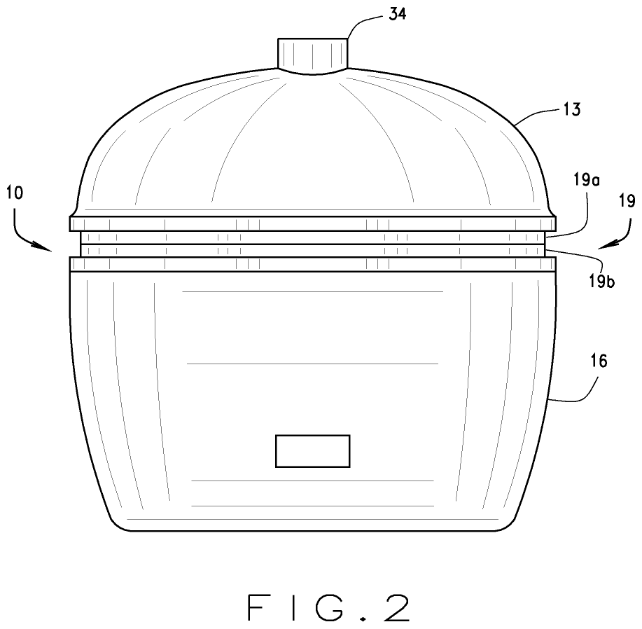

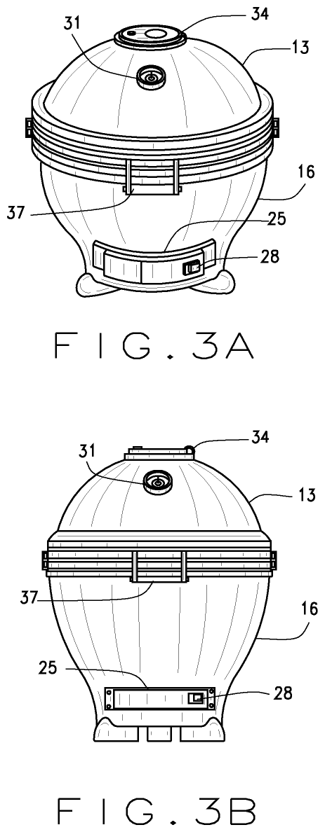

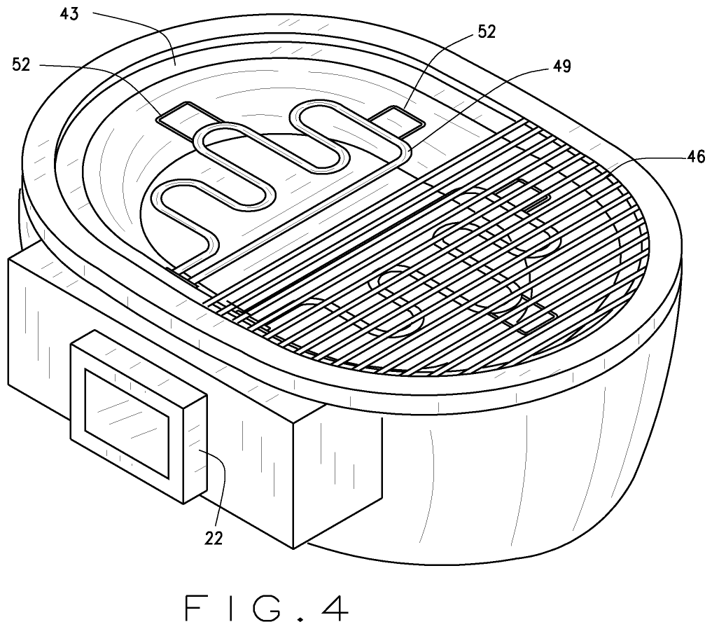

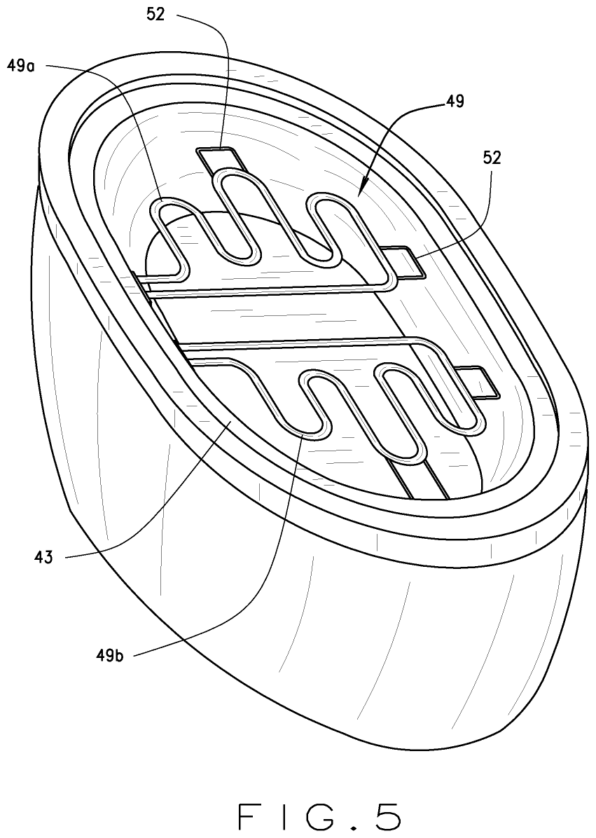

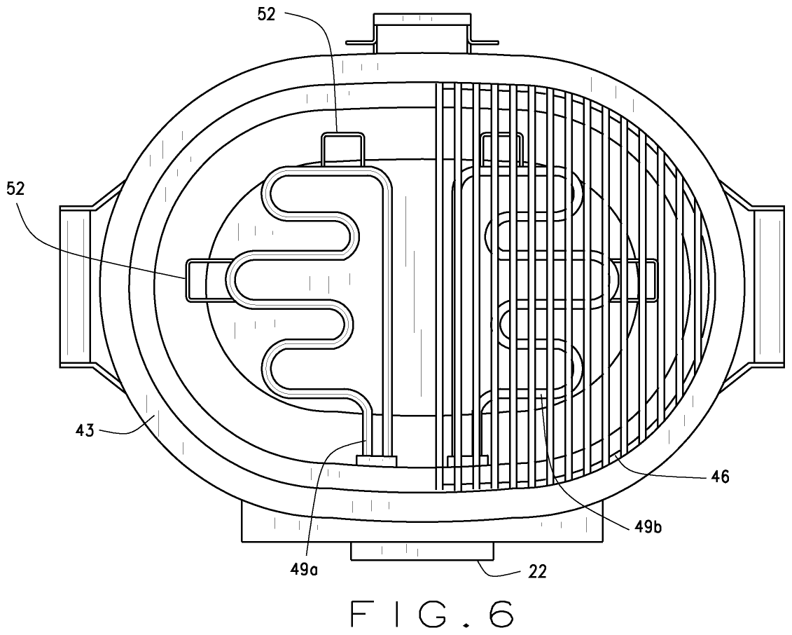

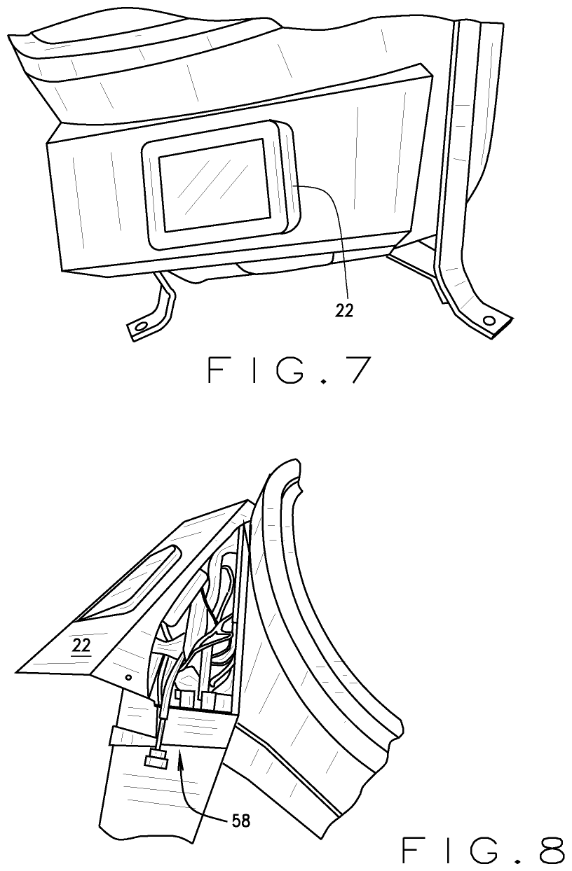

Corresponding reference numerals will be used throughout the several figures of the drawings.

### DETAILED DESCRIPTION

The following detailed description illustrates the claimed invention by way of example and not by way of limitation. This description will clearly enable one skilled in the art to make and use the claimed invention, and describes several embodiments, adaptations, variations, alternatives and uses of the claimed invention, including what we presently believe is the best mode of carrying out the claimed invention. Additionally, it is to be understood that the claimed invention is not limited in its application to the details of construction and the arrangements of components set forth in the following description or illustrated in the drawings. The claimed invention is capable of other embodiments and of being practiced or being carried out in various ways. Also, it is to be understood that the phraseology and terminology used herein is for the purpose of description and should not be regarded as limiting.

A kamado grill 10 is presented herein. The kamado grill 10 is comprised of an outer shell including a top cover 13, a base 16, and a heat seal 19. The top cover 13 includes a thermometer 31, a vent 34, and a handle 37. The base 16 may include a control panel 22, an ash collection region 25 with a front door 28. The top cover 13 and the bottom cover are rotatably attached by a plurality of hinge assemblies 40 such that the top cover 13 is capable of lifting to open the grill 10.

The grill 10 is generally egglike in shape. In the rested position, the egglike shape stands in an upright position with supports affixed to the base 16. The base 16 comprises the bottom half of the egglike shape and the top cover 13 comprises the top half. The ash collection region 25 with the front door 28 is positioned on the front of the base 16 near the bottom but may be positioned on the rear or to one of the sides of the base. The control panel 22 is positioned on the front of the base 16 above the ash collection region 25 about midway to the top of the base. The control panel 22 includes a means for controlling the temperature of the grill, and may include additional features, such as, but not limited to, a timer, vent control, temperature alarms, or others. Handles 37 are positioned on the base 16 at the right and left sides, respectively, for allowing a user to more easily move the grill.

The top cover 13 of the grill 10 is shaped like a dome. The handle 37 is fixed to the bottom front of the top cover 13 and is rigidly secured such that the top cover 13 may be lifted and rotated rearwards to open the top of the grill 10. The thermometer 31 is positioned above the handle 37 midway between the bottom of top cover 13 and the top of the dome, such that a user can easily read the temperature internal to an operational grill. The vent 34 is positioned near the top of the dome and is configured to allow the user to regulate the heat or smoke being released from internal to the grill 10. A pair of hinge assemblies 40 are positioned near the right and left sides of the grill 10, respectively, and are secured at opposite ends to the base 16 and the top cover 13. When a user lifts the top cover 13 of the grill 10, a rotational motion is created in the hinges 40, such that the top cover 13 is rotated upwardly while also shifting towards the rear of the base 16. In a fully opened position, the top cover 13 will be positioned behind the base 16, such that the bottom surface is resting and stabilized in a position generally vertical and perpendicular to the top surface of the base 16.

The heat seal 19 comprises an upper portion 19a and a lower portion 19b affixed to the bottom surface of the top cover 13 and the top surface of the base 16, respectively. The upper portion 19a and the lower portion 19b are composed of similar materials and are mirrored about a plane separating the closed top cover 13 and base 16. Each portion comprises a heat resistant layer 19c made from a heat resistant material that is affixed to the surface by an adhesive layer 19d. In the closed position, the upper portion 19a and the lower portion 19b of the heat seal 19 are mated at the heat resistant layers 19c, thereby creating a seal for trapping heat within the grill 10.

The interior of the grill 10 is generally hollow creating an internal cavity. A lip 43 is cut about the perimeter of the top surface of the base 16 on the interior of the cavity. A grate 46 is sized and positioned to rest on the lip 43, such that it covers the cavity completely. In the open position, the user can place food atop the grate 46 to be cooked when in use.

A heat source 49 is positioned below the grate 46, interior to the cavity. The heat source 49 is comprised of an electric coil that is sized and shaped to heat the grate 46 evenly from below when the grill 10 is in use. A plurality of support fins 52 are positioned on the inner wall of the cavity within the base 16. The support fins 52 are arranged radially, and generally equally spaced to support the weight of the electric heat source 49 from below, such that the weight is supported evenly within the cavity. Below the heat source 49 is an open cavity space with a bottom surface for collecting ash or drippings from food as it is cooked.

The heat source 49 is affixed to the front inner wall of the cavity within the base 16 of the grill 10. The electric coil of the heat source 49 is comprised of a right coil 49a and a left coil 49b, respectively, each coil capable of being controlled individually for regulating the heat output within the interior cavity of the grill 10. The coils 49a,b are electrically connected to the control panel 22 through a hole cut within the front of the base 16 directly behind the control panel 22. The control panel 22 is externally facing to the shell, such that, a user may engage and interact with the control panel 22 from outside the closed grill to electrically activate and control the coils 49a,b individually, thereby turning it on or adjusting the temperature accordingly.

A temperature sensor 55 is positioned within the cavity of the base 16 near the grate 46, such that it is capable of measuring the temperature of the enclosure. The temperature sensor 55 is electrically connected to the control panel 22 for providing temperature information to the user and to internal control circuitry 58 to the control panel 22. The internal control circuitry may include a microcontroller unit (MCU) for receiving this temperature information from the temperature sensor 55. Automatic temperature adjustments may be made by the MCU to either the right or left coils 49a,b based on the feedback from the temperature sensor. The temperature information may also be displayed to the user on a control panel LCD, where the user may make manual temperature adjustments if determined necessary.

An internal temperature monitor 61 for monitoring the internal temperature of the food is electrically connected to the control panel 20. The monitor 61 is positioned external to the grill, such that a user may grab the monitor 61 with his/her hand and insert it into food that is cooking on the grate 46 for measuring the internal temperature, thereby determining the readiness of the cooking food. The temperature reading may then be displayed to the user on the LCD display of the control monitor 22.

The electric coils 49a,b are secured to the front inner wall of the base 16 directly behind the control panel 22. They are electrically connected to the internal control circuitry 58 by any standard electrical connector capable of transmitting all of the required information, and may be secured in place electrical screws, such as a heat resistant VGA port or the like. The coils 49a,b may be further secured using a fastener, such as a nut and bolt, or a removable heat resistant clip. As such, the electrical coils 49a,b are detachable and may be removed from the base 16 of the grill 10 for cleaning or for configuring the grill 10 to use as a wood or charcoal grill.

An internal protective panel 64 is sized to be form fit into position between the inner cavity and the electric control circuitry 58 of the control panel 22. The internal protective panel 64 is composed of an identical material of the base, thereby, when in position, protects the electrical control circuitry 58 of the control panel. With the coils 49a,b removed, the grill 10, can be used as a wood or charcoal grill, thereby enabling the user to use the grill as a smoker or to cook food by charcoal or wood as a fuel.

In view of the above, it will be seen that the several objects and advantages of the present invention have been achieved and other advantageous results have been obtained.

As various changes could be made in the above constructions without departing from the scope of the invention, it is intended that all matter contained in the above description or shown in the accompanying drawings shall be interpreted as illustrative and not in a limiting sense.

1. A cooking device, comprising an outer shell,
the outer shell comprising:
a base, the base comprising a support for the base,
a control panel, and a support for a cooking surface,
a top cover, the top cover comprising a handle and a vent, wherein the top cover is rotatably attached to the base such that the top cover is configured to lift and rotate upwardly away from but remain attached to the shell to open,
a cavity defined interior to the shell when the top cover is closed atop the base, wherein the cooking surface is positioned within the cavity, and the control panel is fixed to the base,
at least one heat source that is electrically connected to the control panel for being activated by a user,
a temperature sensor electrically connected to the control panel interior to the cavity configured to generate an electrical measure that represents the internal temperature of the cavity,
wherein the control panel receives the electrical measure and is configured to adjust the internal temperature of the cavity by adjusting the electrical charge applied to the electric coil, and
wherein the cooking device is an electric kamado-style grill.

2. A cooking device according to claim 1 wherein the heat source is secured to the interior cavity by heat resistant means.

3. A cooking device according to claim 1 wherein the electrical measure is configured to be removed and optionally replaced by an alternative source of heat.

4. A cooking device according to claim 3 further comprising a protective panel for physically safeguarding the control panel,

5. A cooking device according to claim 1 wherein the base contains cavities whereby materials may pass through the base and be collected below the base of the cavity.

6. A cooking device according to claim 1 wherein the control panel is configured to automatically adjust the internal temperature of the cavity by adjusting the electrical charge applied to the electric coil.

7. A cooking device according to claim 1 further comprising a plurality of support fins positioned on an inner wall of the cavity within the base, the support fins being arranged radially, and substantially equally spaced to support the weight of the electric heat source from below, whereby the weight of the electric heat source is supported substantially evenly within the cavity.

8. A method of using an electric grill, said method comprising the steps of:
obtaining a cooking device, comprising an outer shell,
the outer shell comprising:
a base, the base comprising a support for the base,
a control panel, and a support for a cooking surface,
a top cover, the top cover comprising a handle and a vent, wherein the top cover is rotatably attached to the base such that the top cover is configured to lift and rotate upwardly away from but remain attached to the shell to open,
a cavity defined interior to the shell when the top cover is closed atop the base, wherein the cooking surface is positioned within the cavity, and the control panel is fixed to the base,
at least one heat source that is electrically connected to the control panel for being activated by a user,
a temperature sensor electrically connected to the control panel interior to the cavity configured to generate an electrical measure that represents the internal temperature of the cavity,
wherein the control panel receives the electrical measure and is configured to adjust the internal temperature of the cavity by adjusting the electrical charge applied to the electric coil, and wherein the cooking device is an electric kamado-style grill, and
actuating the electric kamado-style grill by setting the control panel to an on position to provide electric generated heat to the electric coil.
